(19) United States
(12) Patent Application Publication
(10) Pub. No.: US 2025/0035963 A1
(43) Pub. Date: Jan. 30, 2025

(54) ADJUSTING OPTICAL PROPERTIES OF GLASSES USING ADAPTIVE OPTICS AND SENSORS

(71) Applicant: Google LLC, Mountain View, CA (US)

(72) Inventors: Lloyd Frederick Holland, Waterloo (CA); Paul Hans Kempf, Waterloo (CA)

(21) Appl. No.: 18/360,551

(22) Filed: Jul. 27, 2023

(51) Int. Cl. G02C 7/08; G02C 7/10

(52) U.S. Cl. CPC G02C 7/083; G02C 7/101

(57) ABSTRACT

Techniques involve a smartglasses device having sensors, processing circuitry, and a lens including an adaptive optical device. The processing circuitry is configured to receive, from the sensors, an indication that a context of the wearer has changed. In response to such an indication, the processing circuitry adjusts a voltage applied to the adaptive optical device. In some implementations, the adaptive optical device includes a liquid crystal optic that is configured to change an optical power of the lens in response to a change in applied voltage. In this way, the smartglasses device enables a wearer to see clearly in a variety of contexts without any manual adjustment of the frame or lenses.

### TECHNICAL FIELD

This description relates in general to using smartglasses sensors to change optical properties of lenses for wearers of glasses.

### BACKGROUND

Correction of presbyopia (reduced visual accommodation) can involve a set of custom lenses, e.g., multi-focal, progressive, and/or additional eyewear, e.g., reading glasses. In one example, a multi-focal lens has at least one horizontal line defining a boundary between focal regions; in this case, a wearer moves their eye up or down to change power for different situations (e.g., looking at a distance in driving or up close in reading). In another example, progressive lenses have a continuous change in focus within a central region defined by a curve, while outside that curve is a diffuse (blur) zone that is not usable.

### SUMMARY

This disclosure relates to a smartglasses device—or wearable device in general—that includes sensors, processing circuitry, and a lens including an adaptive optical device. The processing circuitry is configured to receive, from the sensors, an indication that a context of the wearer has changed. In one example, the wearer may have turned their head to look down at their feet. In another example, the wearer may have gone from looking at a distant object to looking at something up close. In another example, the wearer may have gone from an outdoor environment to an indoor environment. In all of these examples, sensors on the smartglasses device including an inertial measurement unit (IMU), an eye-tracking camera, and a world-facing camera detect the changes in context for the wearer and send an indication to the processing circuitry in such instances. In response to such an indication, the processing circuitry adjusts a voltage applied to the adaptive optical device. In some implementations, the adaptive optical device includes a liquid crystal optic that is configured to change an optical power of the lens in response to a change in applied voltage. In this way, the smartglasses device enables a wearer to see clearly in a variety of contexts without any manual adjustment of the frame or lenses or without switching eyewear (e.g., switching to and from reading glasses to read text up close).

In one general aspect, a method includes receiving, by processing circuitry of a smartglasses device that includes a set of sensors and a lens, the smartglasses device being worn by a wearer, the lens including an adaptive optical device configured to provide the lens with a first set of optical properties in response to a first voltage applied to the adaptive optical device, an indication from at least one sensor of the set of sensors that a context of the wearer has changed from an old context to a new context. The method also includes, in response to the indication, adjusting a voltage applied to the adaptive optical device from the first voltage to a second voltage to cause the adaptive optical device to provide the lens with a second set of optical properties.

In another general aspect, a computer program product comprising a nontransitive storage medium, the computer program product including code that, when executed by processing circuitry, causes the processing circuitry to perform a method. The method includes receiving, by processing circuitry of a smartglasses device that includes a set of sensors and a lens, the smartglasses device being worn by a wearer, the lens including an adaptive optical device configured to provide the lens with a first set of optical properties in response to a first voltage applied to the adaptive optical device, an indication from at least one sensor of the set of sensors that a context of the wearer has changed from an old context to a new context. The method also includes, in response to the indication, adjusting a voltage applied to the adaptive optical device from the first voltage to a second voltage to cause the adaptive optical device to provide the lens with a second set of optical properties.

In another general aspect, an electronic apparatus includes memory and processing circuitry coupled to the memory. The processing circuitry is configured to receive, by processing circuitry of a smartglasses device that includes a set of sensors and a lens, the smartglasses device being worn by a wearer, the lens including an adaptive optical device configured to provide the lens with a first set of optical properties in response to a first voltage applied to the adaptive optical device, an indication from at least one sensor of the set of sensors that a context of the wearer has changed from an old context to a new context. The processing circuitry is also configured to, in response to the indication, adjust a voltage applied to the adaptive optical device from the first voltage to a second voltage to cause the adaptive optical device to provide the lens with a second set of optical properties.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example system, in accordance with implementations described herein.

FIG. 1B is a front view, FIG. 1C is a rear view, and FIG. 1D is a perspective view, of the example head mounted wearable device shown in FIG. 1A, in accordance with implementations described herein.

FIGS. 2A and 2B are diagrams illustrating an adaptive optical device that includes a liquid crystal optic.

FIG. 3 is a diagram illustrating an example electronic environment for adjusting optical properties of a lens automatically in response to a change in context.

FIG. 4 is a flow chart illustrating an example method for adjusting optical properties of a lens automatically in response to a change in context.

### DETAILED DESCRIPTION

Correction of presbyopia (reduced visual accommodation) can involve a set of custom lenses, e.g., multi-focal, progressive, and/or additional eyewear, e.g., reading glasses. In one example, a multi-focal lens has at least one horizontal line defining a boundary between focal regions; in this case, a wearer moves their eye up or down to change power for different situations (e.g., looking at a distance in driving or up close in reading). In another example, progressive lenses have a continuous change in focus within a central region defined by a curve, while outside that curve is a diffuse (blur) zone that is not usable.

At least one technical problem is that the above-described lens solutions—multi-focals, progressive lenses, reading glasses—are static and impose several limitations that can force wearers to adapt and change behaviors in order to see clearly. For example, a wearer may need to turn their head more to keep a point of interest in focus as that point moves. A wearer may need to swap or remove glasses based on activity or slide the glasses down the nose to view objects in the distance.

There are additional examples. While wearing multifocal or progressive lenses, the wearer may not be able to see their feet in clear focus looking down or walk as their eyes are looking through the near power portion of the lens. This makes walking down stairs and navigating curbs more challenging. With progressive lenses, there is a blur zone that limits peripheral vision.

Adaptive optics such as a liquid crystal embedded in the lens can be used to change the lens power. Nevertheless, such adaptive optics requires manual control of the power in order activate the liquid crystal.

At least one technical solution is directed to a smartglasses device having sensors, processing circuitry, and a lens including an adaptive optical device. The processing circuitry is configured to receive, from the sensors, an indication that a context of the wearer has changed. In response to such an indication, the processing circuitry adjusts a voltage applied to the adaptive optical device. In some implementations, the adaptive optical device includes a liquid crystal optic that is configured to change an optical power of the lens in response to a change in applied voltage. In this way, the smartglasses device enables a wearer to see clearly in a variety of contexts without any manual adjustment of the frame or lenses.

A technical advantage of the technical solution is that the wearer does not need to make any manual adjustments to their glasses in order to see more clearly in a variety of contexts.

The term “context” herein refers to a particular situation in which a wearer uses the smartglasses device for seeing objects around the wearer. For example, in one context the user is looking at an object with their head at a particular angle. Specifically, the user may have their head tilted slightly upward to look at distant objects, or facing downward to look at their feet. An IMU is configured to detect a change in the angle in which the wearer's head is tilted and accordingly a change in this context. Such a change in context may require a change in the lens power for the wearer to see clearly.

In a different context, the wearer's pupils are a certain distance apart when looking at an object. In one such context, the pupils are far apart when looking at a distant object and, in another such context, the pupils are closer together when looking at an object up close (e.g., when reading). In this case, an eye-tracking camera is configured to detect a change in vergence (e.g., distance between the pupils) and accordingly a change in context.

The eye tracking camera can also detect eye position relative to the as worn frame position. Using IMU data from the device (frame angle, hence head inclination angle) and the eye position from the ET sensor system, the gaze of the wearer through the lenses can be determined (e.g., looking through the center of the lens, the upper part or lower part of the lens, etc.).

In a different context, the wearer is immersed in an environment with a certain amount of background light. For example, in one context, the wearer is outdoors and there is a plethora of background light, while in another context, the wearer is inside and there is less background light. In this case, a world-facing camera or ambient light sensor is configured to detect a change in seeing environment and accordingly a change in context.

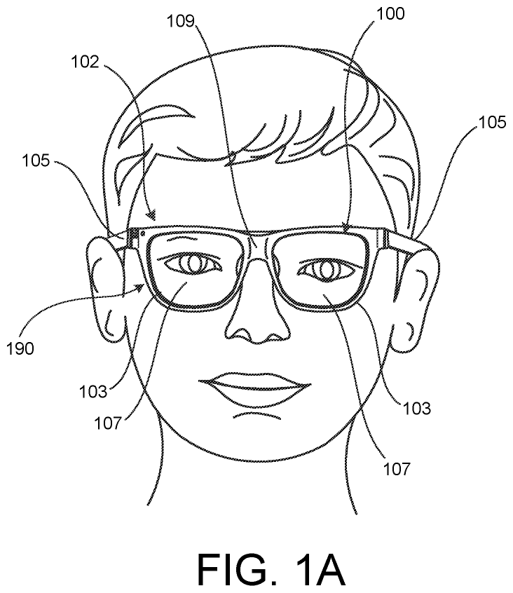

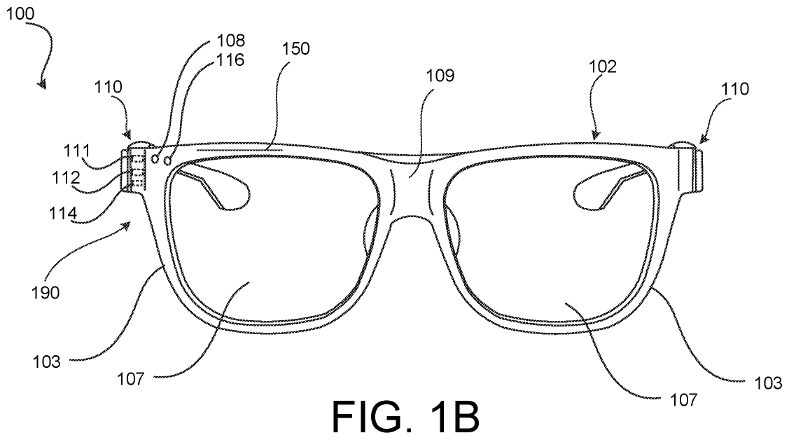

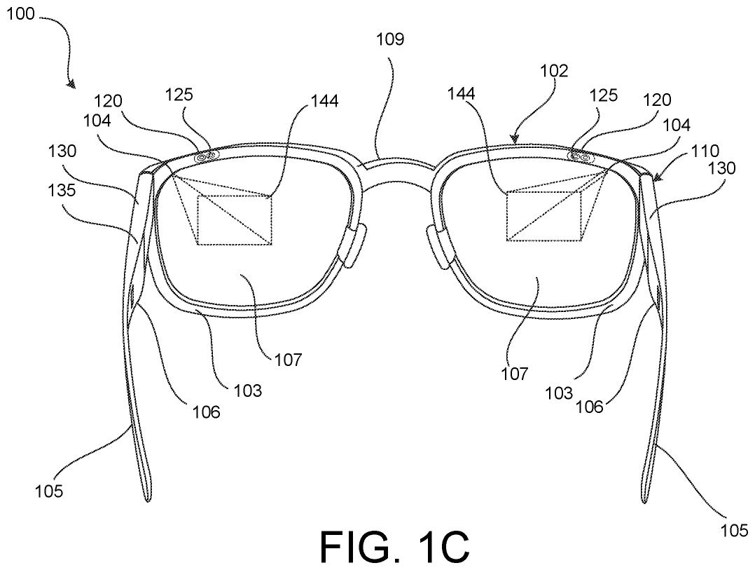

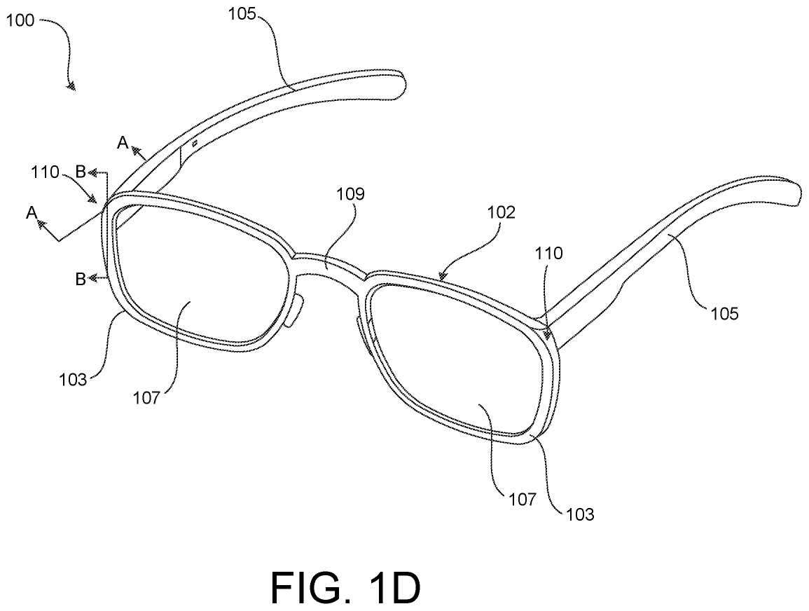

FIG. 1A illustrates a user wearing an example head mounted wearable device 100. In this example, the example head mounted wearable device 100 is in the form of example smartglasses including display capability and computing/processing capability, for purposes of discussion and illustration. The principles to be described herein may be applied to other types of eyewear, both with and without display capability and/or computing/processing capability. FIG. 1B is a front view, FIG. 1C is a rear view, and FIG. 1D is a perspective view, of the example head mounted wearable device 100 shown in FIG. 1A. As noted above, in some examples, the example head mounted wearable device 100 may take the form of a pair of smartglasses, or augmented reality glasses.

As shown in FIGS. 1B-1D, the example head mounted wearable device 100 includes a frame 102. The frame 102 includes a front frame portion defined by rim portions 103 surrounding respective optical portions in the form of lenses 107, with a bridge portion 109 connecting the rim portions 103. Arm portions 105 are coupled, for example, pivotably or rotatably coupled, to the front frame by hinge portions 110 at the respective rim portion 103. In some examples, the lenses 107 may be corrective/prescription lenses. In some examples, the lenses 107 may be an optical material including glass and/or plastic portions that do not necessarily incorporate corrective/prescription parameters.

A display device 104 may be coupled in a portion of the frame 102. In the example shown in FIGS. 1B and 1C, the display device 104 is coupled in the arm portion 105 of the frame 102. With the display device 104 coupled in the arm portion 105, an eye box 140 extends toward the lens(es) 107, for output of content at an output coupler 144 at which content output by the display device 104 may be visible to the user. In some examples, the output coupler 144 may be substantially coincident with the lens(es) 107. In some examples, the head mounted wearable device 100 can also include an audio output device 106 (such as, for example, one or more speakers and microphones), an illumination device 108, a sensing system 111, a control system 112, at least one processor 114, and an image capture device 116, or world-facing camera 116.

In some examples, the display device 104 may include a see-through near-eye display. For example, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 107, next to content (for example, digital images, user interface elements, virtual content, and the like) generated by the display device 104. In some implementations, waveguide optics may be used to depict content on the display device 104.

In some examples, the head mounted wearable device 100 may include an eye tracking device 120 to detect and track eye gaze direction and movement. Data captured by the eye tracking device 120 may be processed to detect and track gaze direction and movement as a user input. In some examples, the sensing system 111 may include various sensing devices such as an inertial measurement unit (IMU) and the control system 112 may include various control system devices including, for example, one or more processors 114 operably coupled to the components of the control system 112. In some examples, the control system 112 may include a communication module providing for communication and exchange of information between the head-mounted wearable device 100 and other external devices.

The world-facing camera 116, the eye tracking device 120, and the IMU form a set of sensors that are configured to send indications of a change in context to processing circuitry included in the one or more processors 114. An indication, in some implementations, takes the form of an electrical signal provided by one of the set of sensors. Such an electrical signal is interpreted by the processing circuitry as corresponding to a particular change in context or no change in context. In some implementations, the processing circuitry is configured to apply machine learning algorithms (such as a convolutional neural network) to determine optical properties of the lens based on the context. Such indications are sent, in some implementations, at regular intervals (e.g., 10 Hz). For example, when a wearer is looking at a distant object, the eye tracking device (eye-tracking camera) 120 sends an indication to the processing circuitry in the form of an image of the wearer's pupils indicating an old gaze angle. Based on the indication, the processing circuitry does not change, e.g., a voltage applied to the adaptive optical device of the lens. Nevertheless, after the wearer begins to look at an object up close, the eye-tracking camera 120 sends a new indication to the processing circuitry, e.g., another image of the wearer's pupils indicating a new gaze angle. As the pupils would be closer together, the processing circuitry would detect a change in context, e.g., the wearer has gone from needing far-field vision to near-field vision.

It should be noted that multiple sensors of the set of sensors may be used together to detect a change in context. For example, the eye tracking camera may be used in conjunction with the the world-facing camera to provide more detailed context changes, e.g., pupil position information used in conjunction with world-facing image information, such as when a wearer holds an object up to read a label.

In response to the change in context, the processing circuitry adjusts the adaptive optical device of the lens by, e.g., changing the voltage applied to the adaptive optical device. In this case, the adaptive optical device includes a liquid crystal optic configured to change lens power in response to a change of applied voltage. In this way, the wearer needs to make no manual adjustments to the lens or to the wearable (smartglasses) device 100; rather, these adjustments are made by the set of sensors and the processing circuitry.

In another example, the IMU sends an indication in the form of an electrical signal to the processing circuitry at regular intervals (e.g., 60 Hz). In one context, in which the wearer has their old head position tilted slightly up or is looking straight ahead at a distant object, the IMU sends the processing circuitry a signal indicating the position of the head and, if the direction has not changed since the previous indication was sent, then the processing circuitry makes no adjustment to the adaptive optical device. Nevertheless, when the wearer changes their head position to a new head position, e.g., looking down, the next IMU signal will indicate this. The processing circuitry then determines that a change of context has occurred and accordingly adjusts a voltage applied to the adaptive optical device to change the lens power. In this way, the wearer does not need to make any manual adjustment to the lens has the wearer looks down.

In another example, the world-facing camera 116 sends an indication in the form of an image to the processing circuitry at regular intervals (e.g., 10 Hz). In one context, in which the wearer is outdoors, the world-facing camera 116 sends the processing circuitry an image of an outdoor viewing environment the user sees and, if the environment has not changed since the last image sent by the world-facing camera 116, then the processing circuitry makes no adjustment to the adaptive optical device. Nevertheless, when the wearer goes indoors and changes the viewing environment to a new viewing environment, the next image from the world-facing camera 116 will reflect this. The processing circuitry then determines that a change in context took place and accordingly adjusts a voltage applied to the adaptive optical device—in this case, an electrochromic coating on the lens—to change the transmissivity of the lens. In this way, the wearer does not need to remove the smartglasses device which may have its lenses tinted outdoors.

In some implementations, the processing circuitry stores a prescription for the wearer that represents parameters of the lens, including lens power, under which the wearer can see clearly in certain situations. For example, a wearer may have a prescription for multi-focal lenses which states a power for near vision and another power for far vision. Such a prescription may guide the processing circuitry to determine the conditions under which to apply a voltage to the adaptive optical device.

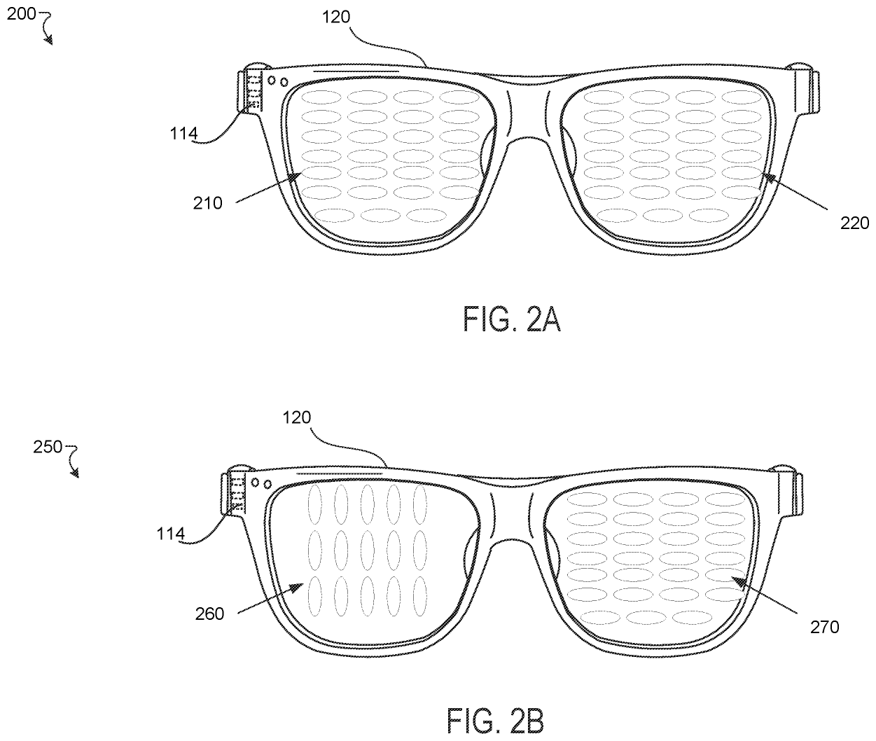

FIG. 2A is a diagram illustrating an example smartglasses device 200 with a liquid crystal optic 210 and 220 in both lenses. The liquid crystal optic 210 and 220 in the lenses is represented as an array of liquid crystals oriented in one direction. As shown in FIG. 2A, the smartglasses device 200 has an eye-tracking camera 120 that is configured to send indications to processing circuitry (included in the at least one processor 114) regarding the wearer's context.

In some implementations, the liquid crystal optic 210 and 220 are laminated on the surface of the lenses. In some implementations, there is a single layer of lamination on the lens surface. In such an implementation, the change in lens power due to the liquid crystal optic 210 or 220 is binary (on/off). In some implementations, there is more than one laminated layer on the surface of the lenses. In such an implementation, the change in lens power may be more fine-grained than that with the single layer of lamination.

FIG. 2B is a diagram illustrating an example smartglasses device 250 with a liquid crystal optic 260 and 270 in both lenses. In smartglasses device 250, however, a voltage has been applied to the liquid crystal optic 260 and not applied to liquid crystal optic 270. That is, in some implementations, the liquid crystal optic in each lens may be activated separately. In some implementations, there is a liquid crystal optic in only one of the lenses.

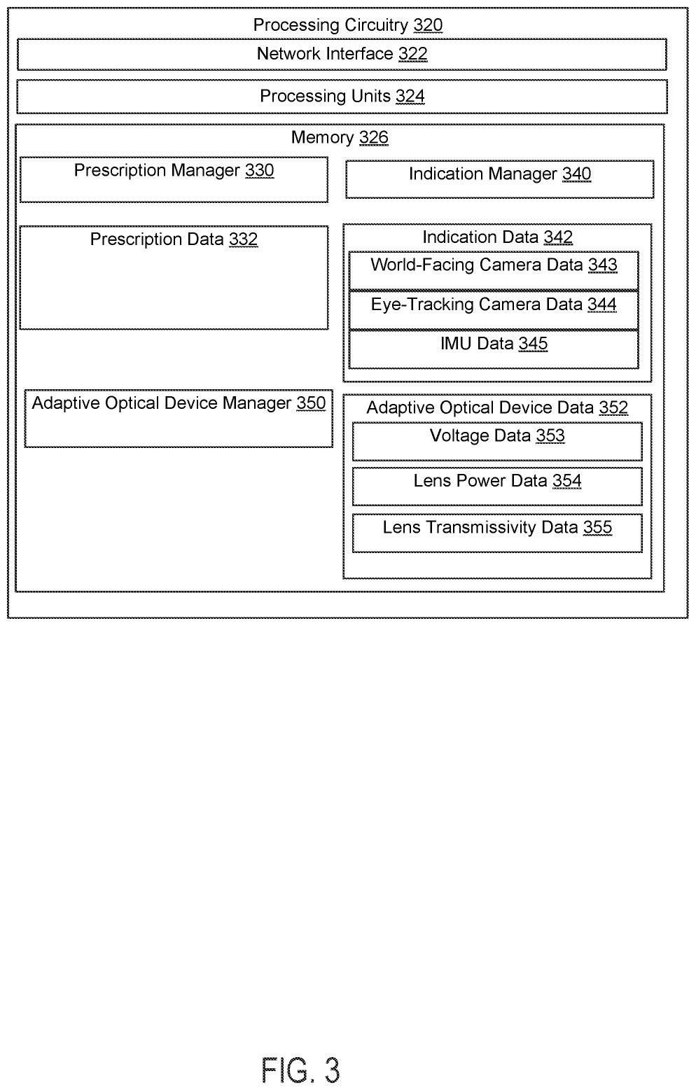

FIG. 3 is a diagram illustrating an example electronic environment for automatically changing the optical properties of a lens in a smartglasses device. The processing circuitry 320 includes a network interface 322, one or more processing units 324, and nontransitory memory (storage medium) 326.

In some implementations, one or more of the components of the processing circuitry 320 can be, or can include processors (e.g., processing units 324) configured to process instructions stored in the memory 326 as a computer program product. Examples of such instructions as depicted in FIG. 3 include prescription manager 330, indication manager 340, and adaptive optical device manager 350. Further, as illustrated in FIG. 3, the memory 326 is configured to store various data, which is described with respect to the respective services and managers that use such data.

The prescription manager 330 is configured to obtain and store a lens prescription for the wearer as prescription data 332. For example, a wearer may have a prescription for multi-focal lenses which states a power for near vision and another power for far vision. Such a prescription may guide the processing circuitry to determine the conditions under which to apply a voltage to the adaptive optical device.

The indication manager 340 is configured to receive an indication from at least one of the sensors (e.g., world-facing camera, IMU, eye-tracking camera) of the smartglasses device that a context of the wearer has changed from an old context to a new context. The indication received is in the form of indication data 342. As shown in FIG. 3, indication data 342 includes world-facing camera data 343, eye-tracking camera data 344, and IMU data 345.

The world-facing camera data 343 represents images taken by the world facing camera (e.g., world-facing camera 116 in FIG. 1B). In some implementations, the images are taken and received by the processing circuitry at a specified rate (e.g., 10 Hz).

The eye-tracking camera data 344 represents images taken by the eye-tracking camera (e.g., eye-tracking camera 120 in FIG. 1C). In some implementations, the images are taken and received by the processing circuitry at a specified rate (e.g., 10 Hz).

The IMU data 345 represents signals generated by the IMU in response to head movement from the user. In some implementations, the signals are generated and received by the processing circuitry at a specified rate (e.g., 60 Hz).

The adaptive optical device manager 350 is configured to apply a control to the adaptive optical device of the smartglasses lens to produce adaptive optical device data 352. In some implementations, the control includes a voltage applied to the adaptive optical device. In some implementations, the adaptive optical device includes a liquid crystal optic. In some implementations, the adaptive optical device includes an electrochromic coating.

As shown in FIG. 3, adaptive optical device data 352 includes voltage data 353, lens power data 354, and lens transmissivity data 355. The voltage data 353 represents the voltage applied to the adaptive optical device. The lens power data 354 represents the lens power currently used in conjunction with the voltage (or lack thereof) applied to a liquid crystal optic. The lens transmissivity data 355 represents the lens transmissivity in conjunction with the voltage (or lack thereof) applied to an electrochromic coating.

The components (e.g., modules, processing units 324) of processing circuitry 320 can be configured to operate based on one or more platforms (e.g., one or more similar or different platforms) that can include one or more types of hardware, software, firmware, operating systems, runtime libraries, and/or so forth. In some implementations, the components of the processing circuitry 320 can be configured to operate within a cluster of devices (e.g., a server farm). In such an implementation, the functionality and processing of the components of the processing circuitry 320 can be distributed to several devices of the cluster of devices.

The components of the processing circuitry 320 can be, or can include, any type of hardware and/or software configured to process private data from a wearable device in a split-compute architecture. In some implementations, one or more portions of the components shown in the components of the processing circuitry 320 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 320 can be, or can include, a software module configured for execution by at least one processor (not shown) to cause the processor to perform a method as disclosed herein. In some implementations, the functionality of the components can be included in different modules and/or different components than those shown in FIG. 3, including combining functionality illustrated as two components into a single component.

The network interface 322 includes, for example, wireless adaptors, and the like, for converting electronic and/or optical signals received from the network to electronic form for use by the processing circuitry 320. The set of processing units 324 include one or more processing chips and/or assemblies. The memory 326 includes both volatile memory (e.g., RAM) and non-volatile memory, such as one or more ROMs, disk drives, solid state drives, and the like. The set of processing units 324 and the memory 326 together form processing circuitry, which is configured and arranged to carry out various methods and functions as described herein.

Although not shown, in some implementations, the components of the processing circuitry 320 (or portions thereof) can be configured to operate within, for example, a data center (e.g., a cloud computing environment), a computer system, one or more server/host devices, and/or so forth. In some implementations, the components of the processing circuitry 320 (or portions thereof) can be configured to operate within a network. Thus, the components of the processing circuitry 320 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 320 can be, or can include, processors configured to process instructions stored in a memory. For example, prescription manager 330 (and/or a portion thereof), indication manager 340 (and/or a portion thereof), and adaptive optical device manager 350 (and/or a portion thereof) are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processing circuitry 320. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processing circuitry 320. As illustrated in FIG. 3, the memory 326 is configured to store various data, including prescription data 332, indication data 342, and adaptive optical device data 352.

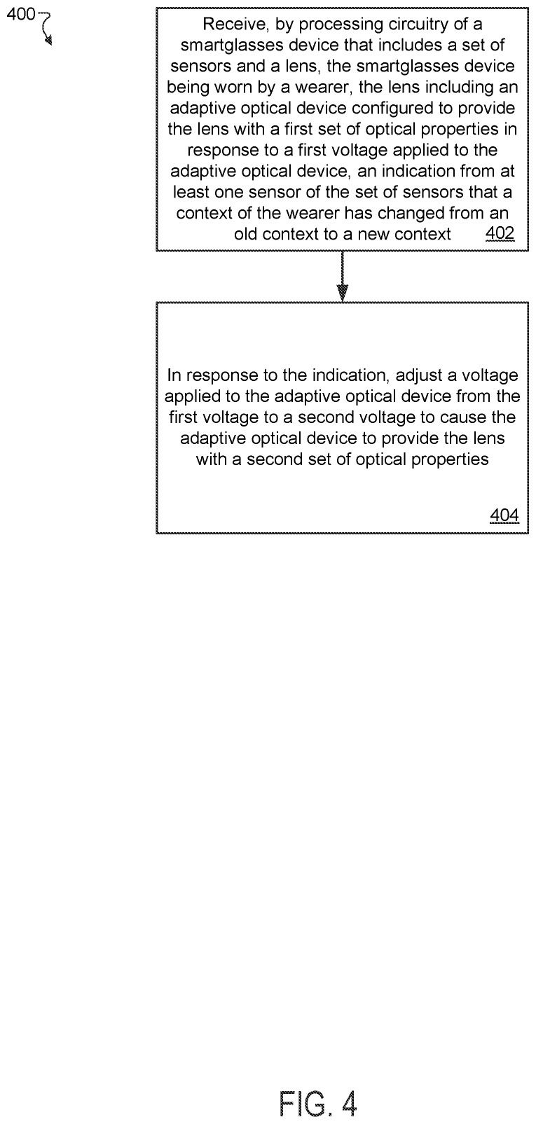

FIG. 4 is a flow chart illustrating an example method 400 for automatically changing the optical properties of a lens in a smartglasses device. The method 400 may be performed using the processing circuitry 320 of FIG. 3.

At 402, the indication manager 340 receives, by processing circuitry of a smartglasses device that includes a set of sensors and a lens, the smartglasses device being worn by a wearer, the lens including an adaptive optical device configured to provide the lens with a first set of optical properties in response to a first voltage applied to the adaptive optical device, an indication from at least one sensor of the set of sensors that a context of the wearer has changed from an old context to a new context.

At 404, the adaptive optical device manager 350, in response to the indication, adjusts a voltage applied to the adaptive optical device from the first voltage to a second voltage to cause the adaptive optical device to provide the lens with a second set of optical properties.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A method, comprising:
receiving, by processing circuitry of a smartglasses device that includes a set of sensors and a lens, the smartglasses device being worn by a wearer, the lens including an adaptive optical device configured to provide the lens with a first set of optical properties in response to a first voltage applied to the adaptive optical device, an indication from at least one sensor of the set of sensors that a context of the wearer has changed from an old context to a new context; and
in response to the indication, adjusting a voltage applied to the adaptive optical device from the first voltage to a second voltage to cause the adaptive optical device to provide the lens with a second set of optical properties.

2. The method as in claim 1, wherein the adaptive optical device includes a liquid crystal lens, the first set of optical properties includes a first focusing power, and the second set of optical properties includes a second focusing power.

3. The method as in claim 2, wherein the old context is an old head position, the new context is a new head position, and the at least one sensor of the set of sensors is an inertial measurement unit (IMU).

4. The method as in claim 2, wherein the old context is an old eye gaze angle, the new context is a new eye gaze angle, and the at least one sensor of the set of sensors is an eye-tracking device.

5. The method as in claim 2, wherein the old context is an old viewing environment, the new context is a new viewing environment, and the at least one sensor of the set of sensors is a world-facing camera.

6. The method as in claim 2, wherein the lens is a first lens and the smartglasses device includes a second lens, the second lens including a second adaptive optical device configured to provide the second lens with a third set of optical properties in response to a third voltage applied to the second adaptive optical device, and
wherein the method further comprises:
in response to the indication, adjusting a voltage applied to the second adaptive optical device from the third voltage to a fourth voltage to cause the second adaptive optical device to provide the second lens with a fourth set of optical properties, the wearer being enabled to see through the second lens more clearly with the fourth set of optical properties in the new context.

7. The method as in claim 2, wherein the liquid crystal lens includes at least one laminated liquid crystal layer.

8. The method as in claim 2, wherein the first focusing power and the second focusing power are based on a prescription for the wearer.

9. The method as in claim 1, wherein the adaptive optical device includes an electrochromic coating configured to change a transmissivity of the lens in response to a change in voltage applied to the adaptive optical device.

10. The method as in claim 1, wherein the wearer is enabled to see through the lens more clearly with the second set of optical properties in the new context.

11. A computer program product comprising a nontransitory storage medium, the computer program product including code that, when executed by processing circuitry, causes the processing circuitry to perform a method, the method comprising:
receiving, by processing circuitry of a smartglasses device that includes a set of sensors and a lens, the smartglasses device being worn by a wearer, the lens including an adaptive optical device configured to provide the lens with a first set of optical properties in response to a first voltage applied to the adaptive optical device, an indication from at least one sensor of the set of sensors that a context of the wearer has changed from an old context to a new context; and
in response to the indication, adjusting a voltage applied to the adaptive optical device from the first voltage to a second voltage to cause the adaptive optical device to provide the lens with a second set of optical properties.

12. The computer program product as in claim 11, wherein the adaptive optical device includes a liquid crystal lens, the first set of optical properties includes a first focusing power, and the second set of optical properties includes a second focusing power.

13. The computer program product as in claim 12, wherein the old context is an old head position, the new context is a new head position, and the at least one sensor of the set of sensors is an inertial measurement unit (IMU).

14. The computer program product as in claim 12, wherein the old context is an old eye gaze angle, the new context is a new eye gaze angle, and the at least one sensor of the set of sensors is an eye-tracking device.

15. The computer program product as in claim 12, wherein the old context is an old viewing environment, the new context is a new viewing environment, and the at least one sensor of the set of sensors is a world-facing camera.

16. The computer program product as in claim 12, wherein the lens is a first lens and the smartglasses device includes a second lens, the second lens including a second adaptive optical device configured to provide the second lens with a third set of optical properties in response to a third voltage applied to the second adaptive optical device, and
wherein the method further comprises:
in response to the indication, adjusting a voltage applied to the second adaptive optical device from the third voltage to a fourth voltage to cause the second adaptive optical device to provide the second lens with a fourth set of optical properties, the wearer being enabled to see through the second lens more clearly with the fourth set of optical properties in the new context.

17. The computer program product as in claim 12, wherein the liquid crystal lens includes at least one laminated liquid crystal layer.

18. The computer program product as in claim 12, wherein the first focusing power and the second focusing power are based on a prescription for the wearer.

19. The computer program product as in claim 11, wherein the adaptive optical device includes an electrochromic coating configured to change a transmissivity of the lens in response to a change in voltage applied to the adaptive optical device.

20. An electronic apparatus, the electronic apparatus comprising:
memory; and
processing circuitry coupled to the memory, the processing circuitry being configured to:
receive, by processing circuitry of a smartglasses device that includes a set of sensors and a lens, the smartglasses device being worn by a wearer, the lens including an adaptive optical device configured to provide the lens with a first set of optical properties in response to a first voltage applied to the adaptive optical device, an indication from at least one sensor of the set of sensors that a context of the wearer has changed from an old context to a new context; and
in response to the indication, adjust a voltage applied to the adaptive optical device from the first voltage to a second voltage to cause the adaptive optical device to provide the lens with a second set of optical properties.

21. The electronic apparatus as in claim 20, wherein the adaptive optical device includes a liquid crystal lens, the first set of optical properties includes a first focusing power, and the second set of optical properties includes a second focusing power.

22. The electronic apparatus as in claim 21, wherein the lens is a first lens and the smartglasses device includes a second lens, the second lens including a second adaptive optical device configured to provide the second lens with a third set of optical properties in response to a third voltage applied to the second adaptive optical device, and
wherein the processing circuitry is further configured to:
in response to the indication, adjust a voltage applied to the second adaptive optical device from the third voltage to a fourth voltage to cause the second adaptive optical device to provide the second lens with a fourth set of optical properties, the wearer being enabled to see through the second lens more clearly with the fourth set of optical properties in the new context.

23. The electronic apparatus as in claim 20, wherein the adaptive optical device includes an electrochromic coating configured to change a transmissivity of the lens in response to a change in voltage applied to the adaptive optical device.
